(19) United States
(12) Patent Application Publication
(10) Pub. No.: US 2009/0164471 A1
(43) Pub. Date: Jun. 25, 2009

(54) Managing Distributed Data

(76) Inventors: Jinmei Shen, Rochester, MN (US); Hao Wang, Rochester, MN (US)

Correspondence Address: IBM CORPORATION, 3605 HIGHWAY 52 NORTH, DEPT 917, ROCHESTER, MN, 55901-7829, US

(21) Appl. No.: 11/959,533

(22) Filed: Dec. 19, 2007

(51) Int. Cl. G06F 17/30

(52) U.S. Cl. 707/10; 707/E17.005

(57) ABSTRACT

A method, system and computer program product for managing distributed data is presented. A first datum, which is represented in an upper tier of a data tree, is received from a client computer by a first upper tier partition server. The first upper tier partition server is part of a plurality of upper tier partitions servers. A partition server manager in the first upper tier partition server identifies at least one other upper tier partition server that contains an other datum from the upper tier of the data tree. The at least one other upper tier partition server is registered with the client, such that the client is able to manage other upper tier data stored in the plurality of other upper tier partition servers.

### BACKGROUND OF THE INVENTION

1. Technical Field

The present disclosure relates in general to the field of computers, and more particularly to the computer software. Still more particularly, the present disclosure relates to distributed databases.

2. Description of the Related Art

Distributed computing allows a system to share resources, including hardware, software and data. Distributed data may be located in multiple hardware systems, including different servers. A client computer needs to be able to seamlessly locate and manage distributed data from different servers in order to effectively utilize the distributed data.

### SUMMARY OF THE INVENTION

A method, system and computer program product for managing distributed data is presented. A first datum, which is represented in an upper tier of a data tree, is received from a client computer by a first upper tier partition server. The first upper tier partition server is part of a plurality of upper tier partitions servers. A partition server manager in the first upper tier partition server identifies at least one other upper tier partition server that contains an other datum from the upper tier of the data tree. The at least one other upper tier partition server is registered with the client, such that the client is able to manage other upper tier data stored in the plurality of other upper tier partition servers.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an exemplary computer in which the present invention may be utilized;

FIG. 2 depicts additional detail of a Partitioned Data Manager (PDM) shown in FIG. 1;

FIG. 3 is a high-level overview of relationships among a client computer, upper tier partition servers, and lower tier partition servers;

FIG. 4 illustrates an exemplary data tree used to depict and organize distributed data; and

FIG. 5 is a flow-chart showing exemplary steps taken to manage distributed data using the PDM shown in FIG. 2.

### DETAILED DESCRIPTION OF THE PREFERRED EMBODIMENT

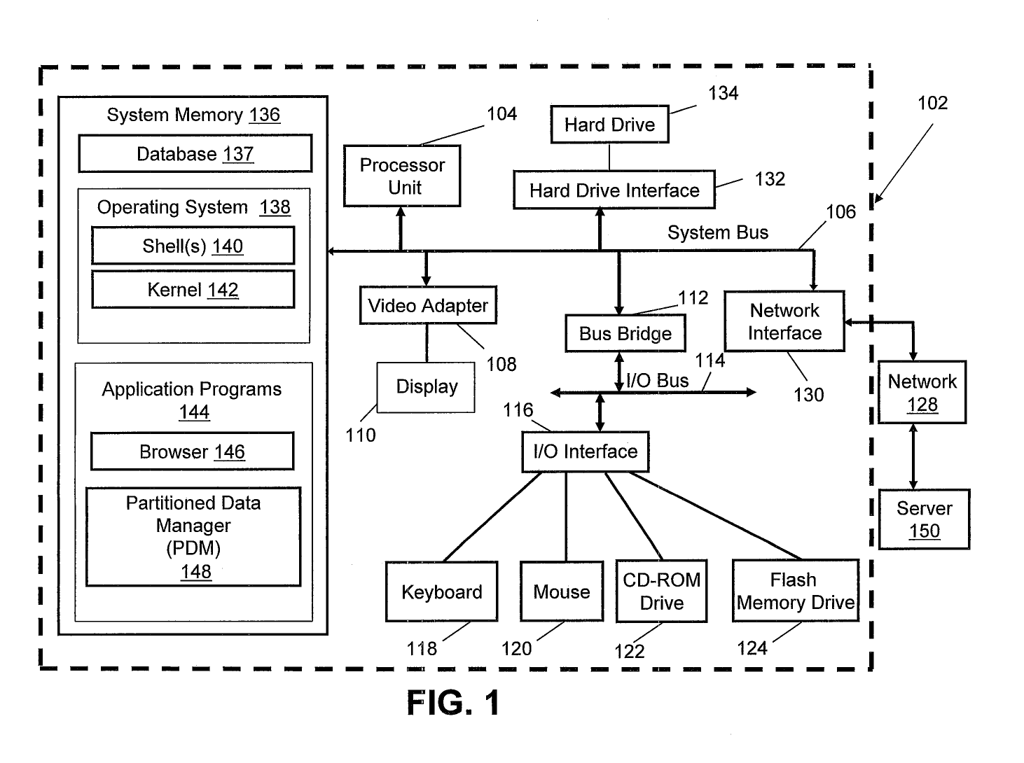

With reference now to FIG. 1, there is depicted a block diagram of an exemplary computer 102, in which the present invention may be utilized. Note that some or all of the exemplary architecture shown for computer 102 may be utilized by software deploying server 150.

Computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash drive memory 124. The format of the ports connected to I/O interface 116 may be any known to those skilled in the art of computer architecture, including but not limited to Universal Serial Bus (USB) ports.

Computer 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Note the software deploying server 150 may utilize a same or substantially similar architecture as computer 102.

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (also called a command processor) is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., computer 102) to send and receive network messages to the Internet using HyperText Transfer Protocol (HTTP) messaging, thus enabling communication with software deploying server 150.

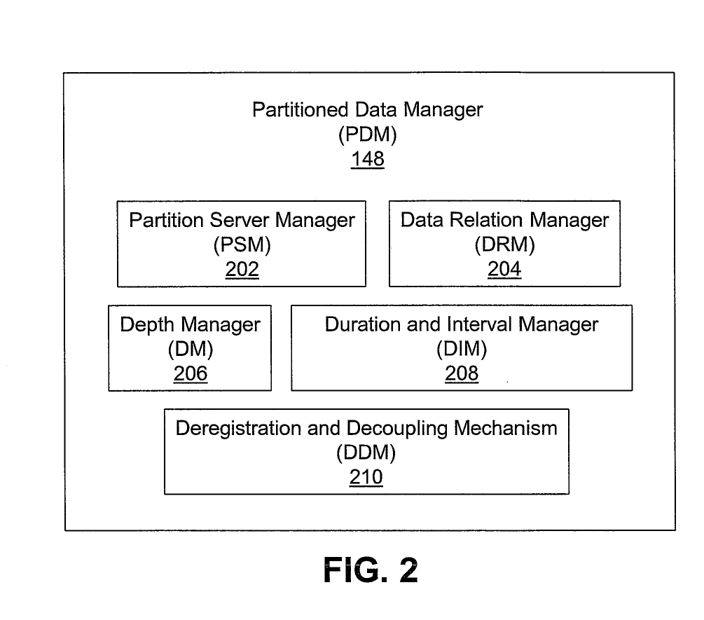

Application programs 144 in computer 102's system memory (as well as software deploying server 150's system memory) also include a Partitioned Data Manager (PDM) 148, which manages data that may be organized and depicted in a data tree described by database 137. PDM 148 includes code for implementing the processes described in FIGS. 2-5. In one embodiment, computer 102 is able to download PDM 148 from software deploying server 150, including in an “on demand” basis, as described in greater detail below in FIGS. 2-5. Note that, in one embodiment of the present invention, software deploying server 150 performs all of the functions associated with the present invention (including execution of PDM 148), thus freeing computer 102 from having to use its own internal computing resources to execute PDM 148.

The hardware elements depicted in computer 102 are not intended to be exhaustive, but rather are representative to highlight essential components required by the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

With reference now to FIG. 2, additional detail of a (PDM) 148, shown in FIG. 1, is presented. PDM 148 may include a Partition Server Manager (PSM) 202; a Data Relation Manager (DRM) 204; a Depth Manager (DM) 206; a Duration and Interval Manager (DIM) 208; and/or a Deregistration and Decoupling Mechanism (DDM) 210.

PSM 202 provides software logic used to locate related distributed data. That is, assume that upper tier data (as organized and depicted in an inverted data tree) is distributed across multiple servers. PSM 202 is able to identify and locate all such upper tier data.

DRM 204 provides software logic used to locate any lower tiered data that is related to upper tier data.

DM 206 provides software logic used to control how deep (i.e., how far down the inverted data tree) a client is authorized to go when searching for secondary data.

DIM 208 provides software logic that controls how often data from multiple servers (that contain upper and lower tier data) is pushed onto a client computer.

DDM 210 provides software logic that controls the deregistration and decoupling (i.e., the deactivation) of distributed data servers to the client computer.

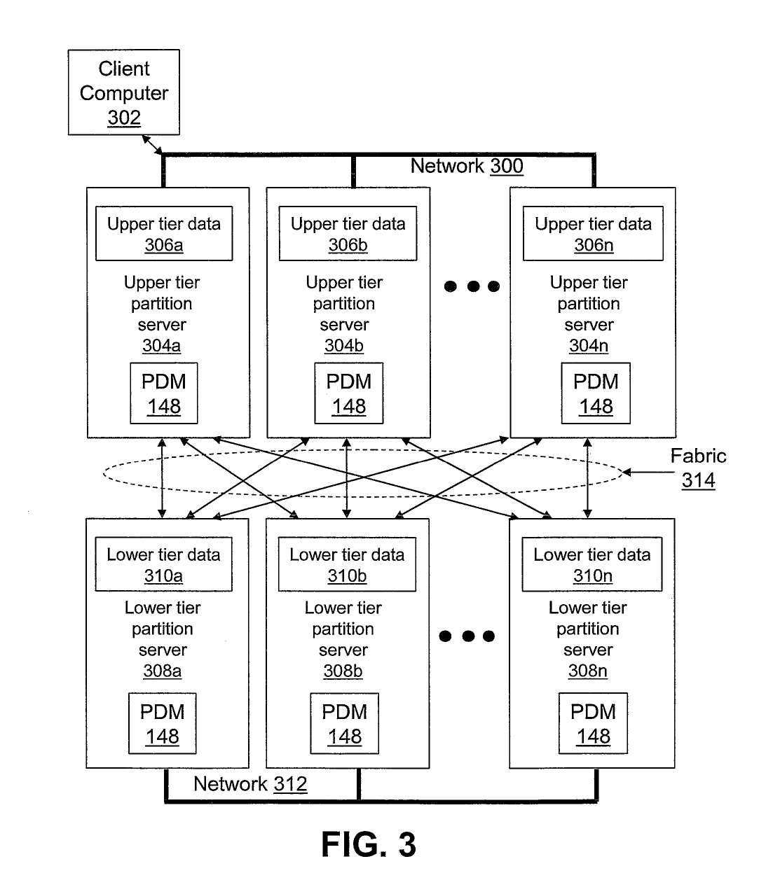

Referring now to FIG. 3, a high-level overview of relationships among a client computer 302, upper tier partition servers 306a-n (where “n” is an integer”), and lower tier partition servers 310a-n is depicted. Note that client computer 302, upper tier partition servers 306a-n, and/or lower tier partition servers 310a-n may utilize the architecture substantially described in FIG. 1 as computer 102.

Assume that a user of client computer 302 desires to manage a piece of data from a distributed data system. For example, assume that the user wants to store names of employees of a company on one or more of the upper tier partition servers 306a-n. The client computer 302 sends a first employee name to the network 300. PDM 148, which may be stored in and function from only upper tier partition server 304a, or alternatively in any or all of the upper tier partition servers 304a, directs the first employee name to be stored as part of upper tier data 306a in upper tier server 304a. PSM 202 (which is part of PDM 148) examines the employee's name, determines that the name is for an employee of Company A, and locates and identifies all other upper tier data 306b-n stored in the other upper tier partition servers 304b-n that also have the names of employees of Company A. PDM 148 sends a message back to client computer 302 informing client computer 302 of the locations of all other upper tier partition servers 304b-n that also contain the names of other employees of Company A.

PDM 148, stored in client computer 302, one or more of the upper tier partition servers 304a-n, and/or one or more of the lower tier partition servers 308a, is also able to locate lower tier data 310a-n in one or more of the lower tier partition servers 308a-n, which are coupled together by a network 312, and which communicate with the upper tier partition servers 304a-n via a fabric 314. The lower tier data 310a-n represents data that is lower than the upper tier data 306a-n (i.e., subordinate to higher node data in a data tree).

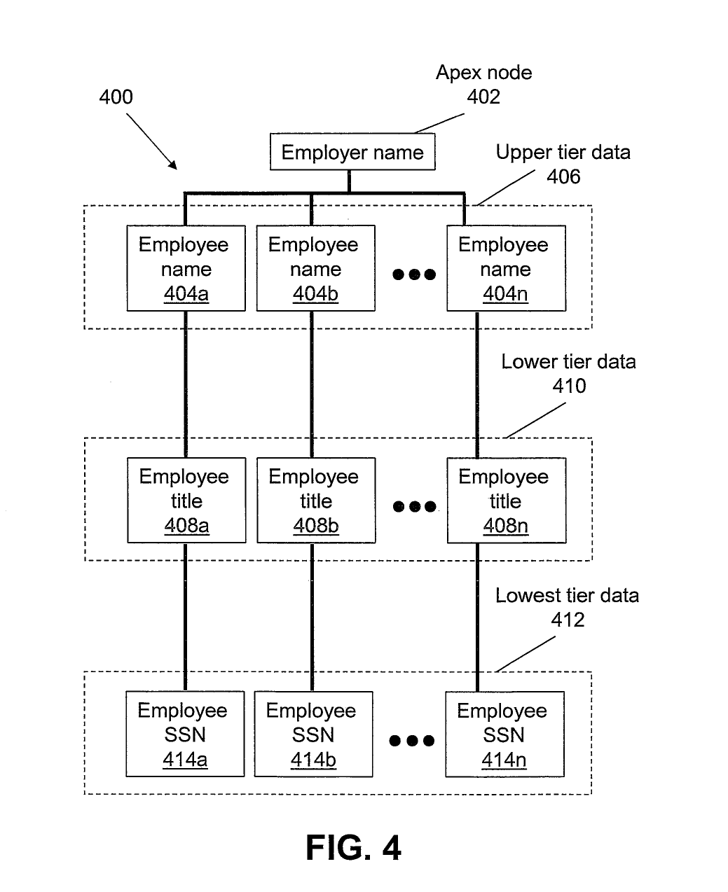

Referring now to FIG. 4, an exemplary data tree used to depict and organize distributed data is illustrated. As described above, upper tier data is higher on a data tree than lower tier data. For example, in data tree 400, the highest level data is found at apex node 402, which for exemplary purposes, is depicted as containing a name of an employer (e.g., Company A). The upper tier data 406 (e.g., upper tier data 306a-n shown in FIG. 3) includes data 404a-n, which are the names of employees of Company A. Note that, as described in FIG. 3, one or more of the datum (e.g., 404a-n) from upper tier data 406 may be stored in different upper tier partition servers.

Subordinate to the upper tier data 406 are the lower tier data 410, made up of data 408a-n, which are the respective titles of named employees described in upper tier data 406. Likewise, subordinate to the lower tier data 410 is a lowest tier data 412, made up of data 414a-n, which are the respective social security numbers associated with the employee titles (and their respective employee names) found in the lower tier data 410. While only three tiers of data plus an apex are depicted, it is understood that there may be additional lower layers of data tiers. In one embodiment, however, the lower the data tier, the higher the sensitivity of data stored in the progressively lower tiers. That is, an employee's social security number (found in lowest tier data 412) is more sensitive than that employee's job title (found in lower tier data 410), which is more sensitive than the employees names (upper tier data 406) or employer (apex node 402).

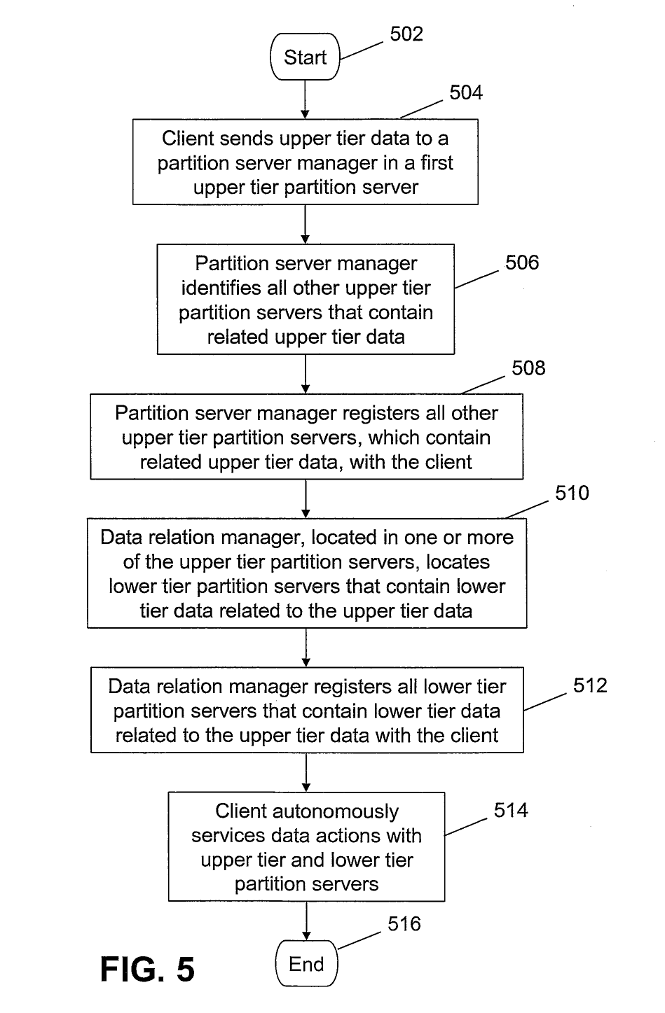

With reference now to FIG. 5, which is to be read in the context of elements described above in FIGS. 1-4, a flow-chart showing exemplary steps taken to manage distributed data is presented. After initiator block 502, which may be prompted by a user desiring to create, add or update distributed data, an upper tier partition server receives a first datum (which is part of upper tier data) from a client computer (block 504). The upper tier partition server, as described in the figures above, is one of multiple servers that handle upper tier data (data that is high in a data tree). A partition server manager in the upper tier partition server examines the first datum, and identifies all other related upper tier data and the other upper tier server partitions that service such upper tier data (block 506). These other upper tier server partitions are then registered with the client computer (block 508). Since the client computer now “knows” where the related upper tier data is located, the client computer can directly manage all of its upper tier data, including creating such data, adding new data, polling for changes to the data, etc.

As described in block 510, the upper tier partition server(s) can also locate, using a data relation manager in one or more of the upper tier partition servers, lower tier partition servers that handle related lower tier data (such as the data described in the example shown above in FIG. 4. These lower tier partition servers are also registered with the client computer (block 512), so that the client computer can directly manage lower tier data as well as the upper tier data. As described above, there may be several layers of lower tiers. A depth manager, preferably located in one of the upper tier partition servers to ensure security control, controls how “deep” down the data tree a particular client computer (and/or user) is permitted to access data from.

As described in block 514, the client computer can autonomously service data action in the upper and lower tier server partitions. For example, the client computer can now automatically and/or periodically poll the upper and lower tier server partitions for changes in data, etc.

The process ends at terminator block 516, when the client computer is deregistered and decoupled from the upper and lower tier server partitions. This deregistration (deregistering the ancillary locations of data in the different tiers in different servers) and decoupling of the client computer (from the different tiered server partitions) may be performed by a deregistration and decoupling mechanism that is located in any of the upper tier partition servers (in order to control the client computer's access to such servers).

As described herein, relational data can be partitioned, such that different components of the data are stored and maintained in different servers. If the relational data is organized into different hierarchies (e.g., as an inverted tree), then the top level (e.g., “employee names”) can be partitioned and stored into different servers, and lower levels (e.g., social security numbers, phone numbers, job titles, etc.) can also be partitioned and stored in different servers. The present invention allows a novel process for managing such relational data.

Utilizing the presently described invention, consider the following summary of the example described above for exemplary purposes. A group of employee names has been divided up into many units, with each unit being stored in a different server. A client may want to update or add a first employee name to a database. To do so, the client sends the first employee's name to a first server, which recognizes the employee's name as being that of an employee of Company A. Later, the client may want to add/update a second employee's information. However, the second employee's name may be in another server (which is different from the server that stored the first employee's name). In order for the client to locate where the second employee's name is located, a server partition manager has found all servers that store names of employees for Company A. This information has been passed back to the client, so the client knows where to send the information for the second employee. This information also allows the client to know which servers need to be periodically polled for changes to the employee names.

Continuing with the example, a data relation manager, which is in one or more of the servers, also locates any data that is related to the employees' names (e.g., titles, phone numbers, social security numbers, etc.) The location of this related data is also sent to the client, so the client can update any changes to this related data.

As described above, to control how deep the client can look (i.e., how far down the tree he is authorized to look), a depth manager limits how deep the client can look at related data. Similarly, a duration and interval manager controls how often data changes are pushed onto the client, both for the primary (upper level) data as well as the related (lower level) data.

While the present invention has been particularly shown and described with reference to a preferred embodiment, it will be understood by those skilled in the art that various changes in form and detail may be made therein without departing from the spirit and scope of the invention. For example, while the present description has been directed to a preferred embodiment in which custom software applications are developed, the invention disclosed herein is equally applicable to the development and modification of application software. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implemented method of managing distributed data, the method comprising:
receiving a first datum from a client computer, wherein the first datum is represented in an upper tier of a data tree, and wherein the first datum is received by a first upper tier partition server that is part of a plurality of upper tier partitions servers;
identifying, by a partition server manager in the first upper tier partition server, at least one other upper tier partition server that contains an other datum from the upper tier of the data tree, wherein the at least one other upper tier partition server is from the plurality of upper tier partition servers; and
registering the at least one other upper tier partition server with the client, wherein the client is able to directly manage other upper tier data stored in the plurality of other upper tier partition servers.

2. The computer-implemented method of claim 1, further comprising:
locating, by a data relation manager in one of the plurality of upper tier partition servers, at least one lower tier partition server, wherein the at least one lower tier partition server contains only data from a lower tier of the data tree; and
registering the at least one lower tier partition server with the client, wherein the client is able to identify and locate datum, from the lower tier of the data tree, that is related to the first datum from the upper tier of the data tree.

3. The computer-implemented method of claim 2, further comprising:
automatically refreshing data from the plurality of upper tier partition servers and the plurality of lower tier partition servers to the client, wherein automatic refreshing is performed by a duration and interval manager that is executed by one or more of the plurality of upper tier partition servers.

4. The computer-implemented method of claim 1, further comprising:
utilizing a depth manager, in one of the plurality of upper tier partition servers, to control client access to subsequently lower tiers of the data tree.

5. The computer-implemented method of claim 1, further comprising:
deregistering and decoupling the client from the plurality of upper tier partition servers, wherein the deregistering and decoupling are performed by a deregistration and decoupling mechanism that is executed by one or more of the plurality of upper tier partition servers.

6. The computer-implemented method of claim 1, wherein the upper tier of the data tree is subordinate to an apex node in the data tree, and wherein the partition server manager identifies the at least one other upper tier partition server by locating other upper tier datum that is also subordinate to the apex node in the data tree.

7. A system comprising:
a processor;
a data bus coupled to the processor;
a memory coupled to the data bus; and
a computer-usable medium embodying computer program code, the computer program code comprising instructions executable by the processor and configured for managing distributed data by:
receiving a first datum from a client computer, wherein the first datum is represented in an upper tier of a data tree, and wherein the first datum is received by a first upper tier partition server that is part of a plurality of upper tier partitions servers;
identifying, by a partition server manager in the first upper tier partition server, at least one other upper tier partition server that contains an other datum from the upper tier of the data tree, wherein the at least one other upper tier partition server is from the plurality of upper tier partition servers; and
registering the at least one other upper tier partition server with the client, wherein the client is able to manage other upper tier data stored in the plurality of other upper tier partition servers.

8. The system of claim 7, wherein the instructions are further configured for:
locating, by a data relation manager in one of the plurality of upper tier partition servers, at least one lower tier partition server, wherein the at least one lower tier partition server contains only data from a lower tier of the data tree; and
registering the at least one lower tier partition server with the client, wherein the client is able to identify and locate datum, from the lower tier of the data tree, that is related to the first datum from the upper tier of the data tree.

9. The system of claim 8, wherein the instructions are further configured for:
automatically refreshing data from the plurality of upper tier partition servers and the plurality of lower tier partition servers to the client, wherein automatic refreshing is performed by a duration and interval manager that is executed by one or more of the plurality of upper tier partition servers.

10. The system of claim 7, wherein the instructions are further configured for:
utilizing a depth manager, in one of the plurality of upper tier partition servers, to control client access to subsequently lower tiers of the data tree.

11. The system of claim 7, wherein the instructions are further configured for:
deregistering and decoupling the client from the plurality of upper tier partition servers, wherein the deregistering and decoupling are performed by a deregistration and decoupling mechanism that is executed by one or more of the plurality of upper tier partition servers.

12. The system of claim 7, wherein the upper tier of the data tree is subordinate to an apex node in the data tree, and wherein the partition server manager identifies the at least one other upper tier partition server by locating other upper tier datum that is also subordinate to the apex node in the data tree.

13. A computer-readable medium comprising a stored computer program, the computer program comprising computer executable instructions configured for:
receiving a first datum from a client computer, wherein the first datum is represented in an upper tier of a data tree, and wherein the first datum is received by a first upper tier partition server that is part of a plurality of upper tier partitions servers;
identifying, by a partition server manager in the first upper tier partition server, at least one other upper tier partition server that contains an other datum from the upper tier of the data tree, wherein the at least one other upper tier partition server is from the plurality of upper tier partition servers; and
registering the at least one other upper tier partition server with the client, wherein the client is able to manage other upper tier data stored in the plurality of other upper tier partition servers.

14. The computer-readable medium of claim 13, wherein the instructions are further configured for:
locating, by a data relation manager in one of the plurality of upper tier partition servers, at least one lower tier partition server, wherein the at least one lower tier partition server contains only data from a lower tier of the data tree; and
registering the at least one lower tier partition server with the client, wherein the client is able to identify and locate datum, from the lower tier of the data tree, that is related to the first datum from the upper tier of the data tree.

15. The computer-readable medium of claim 14, wherein the instructions are further configured for:
automatically refreshing data from the plurality of upper tier partition servers and the plurality of lower tier partition servers to the client, wherein automatic refreshing is performed by a duration and interval manager that is executed by one or more of the plurality of upper tier partition servers.

16. The computer-readable medium of claim 13, wherein the instructions are further configured for:
utilizing a depth manager, in one of the plurality of upper tier partition servers, to control client access to subsequently lower tiers of the data tree.

17. The computer-readable medium of claim 13, wherein the instructions are further configured for:
deregistering and decoupling the client from the plurality of upper tier partition servers, wherein the deregistering and decoupling are performed by a deregistration and decoupling mechanism that is located in any of the plurality of upper tier partition servers.

18. The computer-readable medium of claim 13, wherein the upper tier of the data tree is subordinate to an apex node in the data tree, and wherein the partition server manager identifies the at least one other upper tier partition server by locating other upper tier datum that is also subordinate to the apex node in the data tree.

19. The computer-readable medium of claim 13, wherein the computer-readable medium is a component of a remote server, and wherein the computer executable instructions are deployable to a supervisory computer from the remote server.

20. The computer-readable medium of claim 13, wherein the computer executable instructions are capable of being provided by a service provider to a customer on an on-demand basis.
